(19) United States
(12) Patent Application Publication
(10) Pub. No.: US 2009/0262525 A1
(43) Pub. Date: Oct. 22, 2009

(54) STREET LAMP SYSTEM

(75) Inventor: Chih-Ming Lai, Chu-Nan (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/274,493

(22) Filed: Nov. 20, 2008

(30) Foreign Application Priority Data
Apr. 21, 2008 (CN) 200810301219.X

(51) Int. Cl. F21L 13/00; H02J 7/00

(52) U.S. Cl. 362/192; 320/101

(57) ABSTRACT

A street lamp system includes a hollow lamp post, an illumination device, a generator, a wind turbine, a connecting shaft and a plurality of fan blades. The lamp post defines an air flowing channel therein. The illumination device includes a solid-state light source and a heat dissipation device disposed in the channel. The connecting shaft is mechanically coupled to the wind turbine and the generator. The wind turbine, cooperated with the generator, converts wind energy into electric energy and supplies electric energy to the solid-state light source. The fan blades is configured for directing flowing of the air in the channel from the air inlet to the air outlet.

### CROSS-REFERENCE TO RELATED APPLICATIONS

This application is related to the following commonly-assigned copending application: Ser. No. 12/257,779, entitled “STREET LAMP SYSTEM”. Disclosure of the above-identified application is incorporated herein by reference.

### BACKGROUND

1. Field of the Invention

The present invention relates to street lamp systems, and particularly to a street lamp system utilizing wind energy to supply electric energy to a solid-state light source and improve heat dissipation efficiency thereof.

2. Description of Related Art

In recent years, due to their excellent light quality and high luminous efficiency, light emitting diodes (LEDs) have been increasingly applied to substitute for cold cathode fluorescent lamps (CCFL) as light source of an illumination device, referring to “Solid-State Lighting: Toward Superior Illumination” by Michael S. Shur, et al., Proceedings of the IEEE, Vol. 93, NO. 10 (October, 2005).

Illuminating stability of the LEDs is affected by heat generated from the LEDs. When the temperature of the LEDs is too high, light intensity of the LEDs may gradually attenuate, shortening the lifespan of the illumination devices. Thus, some illumination devices include heat dissipation devices, such as exhaust fans, thermoelectric coolers, etc., to dissipate heat. However, the heat dissipation devices require a great amount of electricity to function, such that application of the heat dissipation devices can defeat the purpose of saving energy by using LEDs.

What is needed, therefore, is an improved street lamp system which can overcome the above shortcomings.

### SUMMARY

A street lamp system includes a hollow lamp post, an illumination device, a generator, a wind turbine, a connecting shaft and a plurality of fan blades. The lamp post has an air inlet and an air outlet, and an air flowing channel defined in the lamp post between the air inlet and the air outlet. The illumination device includes a solid-state light source and a heat dissipation device thermally coupled to the solid-state light source. The illumination device is coupled to the lamp post with the heat dissipation device disposed in the air flowing channel. The generator is electrically connected to the illumination device to supply electric energy to the illumination device. The wind turbine is mechanically coupled to and disposed outside the lamp post to be driven by wind energy to rotate. The connecting shaft is mechanically coupled to the wind turbine and the generator, and driven by the wind turbine to rotate, thereby driving the generator to generate electric energy. The fan blades are mechanically coupled to the connecting shaft and disposed in the hollow lamp post to be driven by the connecting shaft to rotate, thereby directing flowing of the air in the channel from the air inlet to the air outlet.

Other advantages and novel features of the present street lamp system will become more apparent from the following detailed description when taken in conjunction with the accompanying drawings, in which:

### BRIEF DESCRIPTION OF THE DRAWINGS

Many aspects of the present street lamp system can be better understood with reference to the following drawings. The components in the drawings are not necessarily drawn to scale, the emphasis instead being placed upon clearly illustrating the principles of the present illumination device. Moreover, in the drawings, like reference numerals designate corresponding parts throughout the several views.

FIG. 1 is a schematic, isometric view of a street lamp system, in accordance with a first embodiment.

FIG. 2 is a schematic, isometric view of a street lamp system, in accordance with a second embodiment.

FIG. 3 is a schematic, isometric view of a street lamp system, in accordance with a third embodiment.

### DETAILED DESCRIPTION

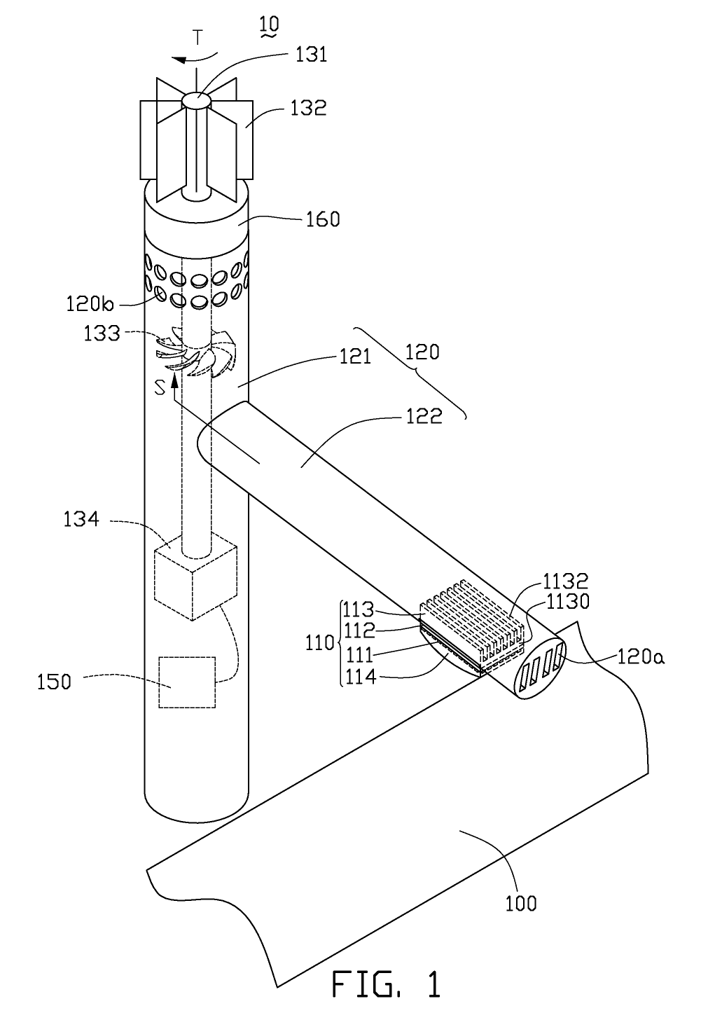

Referring to FIG. 1, a street lamp system 10, in accordance with a first embodiment, includes an illumination device 110, a hollow lamp post 120, a connecting shaft 131, a wind turbine 132, a plurality of fan blades 133 and a generator 134.

The illumination device 110 includes a plurality of solid-state light sources 111, a circuit board 112, a heat dissipation device 113 and a light permeable cover 114. The solid-state light sources 111 can be fluorescent lamps or incandescent lamps, or preferably, LEDs. The heat dissipation device 113 is a heat sink, which includes a base 1130 and a plurality of fins 1132 extending from the base 1130 and substantially perpendicular to the base 1130. The LEDs 111 are mounted on the circuit board 112. The base 1130 of the heat dissipation device 113 thermally contacts the circuit board 112, with the fins 1132 positioned at a side of the circuit board 112 facing away from the LEDs 111. The light permeable cover 114 is disposed opposite to the base 1130 and covers the LEDs 111. The light permeable cover 114 is generally made of transparent materials, such as glass or plastic materials. In addition, the light permeable cover 114 can be a plate, a lens array or a lens.

The lamp post 120 includes a main post 121 and a subaltern post 122 extending sidewardly from the main post 121. The main post 121 and the subaltern post 122 are hollow and communicate with each other. The subaltern post 122 defines an air inlet 120a in an end thereof distal from the main post 121. The main post 121 defines an air outlet 120b in a top end thereof. An air flowing channel (shown by the arrowhead S in FIG. 1) is defined in the lamp post 120 between the air inlet 120a and the air outlet 120b. The illumination device 110 is coupled to the subaltern post 122, with the heat dissipation device 113 arranged in the air flowing channel S and the fins 1132 thereof parallel with a direction along the air flowing channel S, and some other parts, such as the LED 111 mounted to and below the subaltern post 122. The subaltern post 122 provides some sort of waterproof and dustproof functions for the heat dissipation device 113.

The street lamp system 10 further includes a bearing 160 mounted to a top end of the main post 121 adjacent to the connecting shaft 131. The connecting shaft 131 is mechanically coupled to the top end of the main post 121 and coaxial with the main post 121. One end of the connecting shaft 131 is mechanically coupled to the wind turbine 132 and the other end is mechanically couple to the generator 134. The fan blades 133 are arranged in the air flowing channel S, and mechanically coupled to the connecting shaft 131. In addition, the wind turbine 132 is arranged outside the main post 121, and the generator 134 is arranged towards a lower end in the main post 121.

In operation, the lamp post 120 is positioned on an edge of a traffic lane 100. The wind turbine 132 is driven by wind energy to rotate (the rotating direction is shown by the arrowhead T in FIG. 1), thus bringing along the connecting shaft 131 and the fan blades 133 to rotate. When the connecting shaft 131 rotates, the generator 134 can be driven to generate electric energy, that is, wind energy is converted into electric energy. The electric current is applied to the LEDs 111 to illuminate the traffic lane 100. The LEDs 111 generates heat during operation. The heat is transferred to the heat dissipation device 113. Meanwhile, the fan blades 133 rotate to draw external air through the air inlet 120a into the lamp post 120. The air flows through the air flowing channel S to bring away heat accumulated on the heat dissipation device 113 and exits through the air outlet 120b. Therefore, efficiency of the heat dissipation of the LEDs 111 is improved, and the illumination device 110 may operate continually in a certain temperature range, achieving stable optical performance.

The street lamp system 10 can further includes an electric power storage 150, such as a storage battery, to store and reserve electric energy generated by the generator 134. Therefore, electric energy can also be applied to the LEDs 111 to illuminate the traffic lane 100 in no wind case.

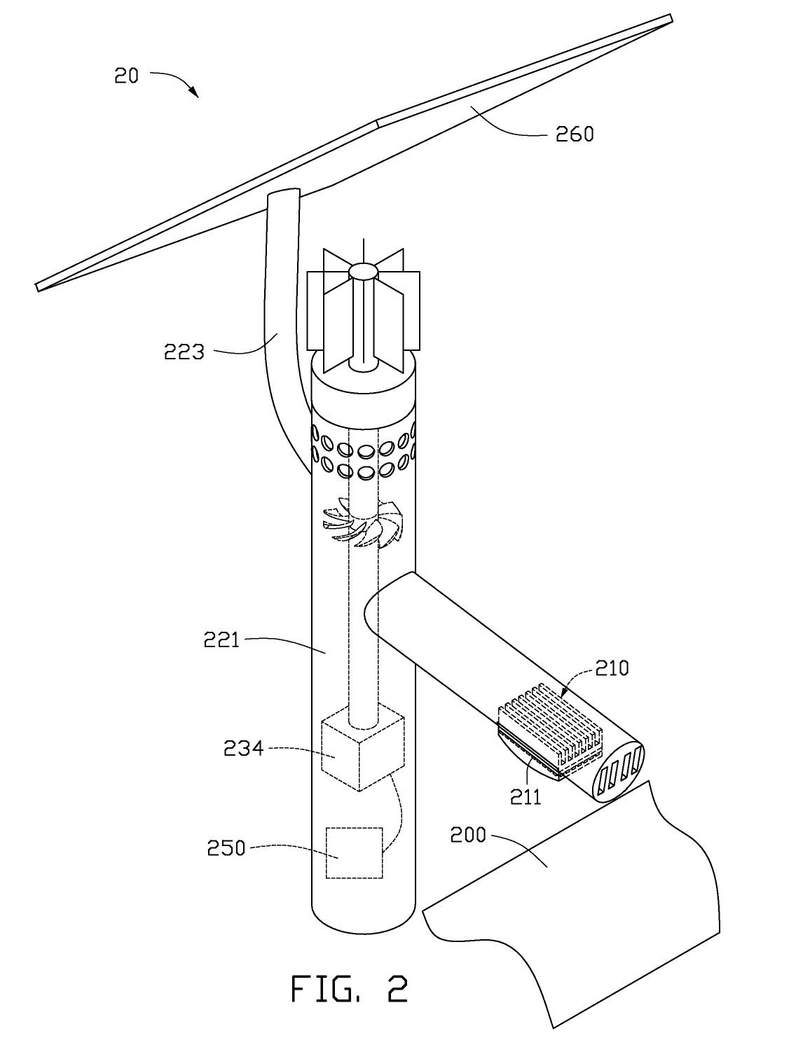

FIG. 2 shows a street lamp system 20, in accordance with a second embodiment, differing from the street lamp system 10 of the first embodiment in the inclusion of a supporting post 223 and a solar cell panel 260. The supporting post 223 extends from the main post 221. The solar cell panel 260 is coupled to the supporting post 223 and electrically connected to the electric power storage 250. In operation, the solar cell panel 260 is exposed to emission of solar light, to absorb and convert solar energy into electric energy. The electric energy then is stored and reserved in the electric power storage 250. In such that, by converting solar energy and wind energy via the solar cell panel 260 and the generator 234 respectively, sufficient electric energy can be applied to the LEDs 211 of the illumination device 210 to illuminate the traffic lane 100.

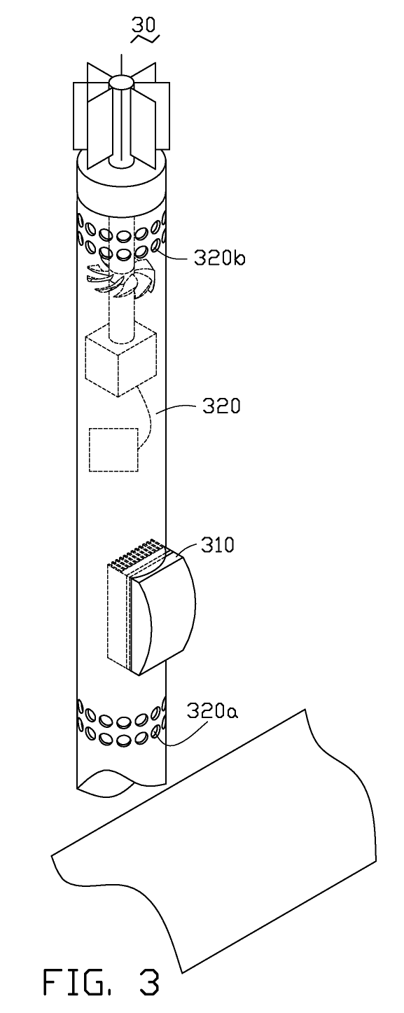

FIG. 3 shows a street lamp system 30, in accordance with a third embodiment. The street lamp system 30 is distinguished from the street lamp system 10 of the first embodiment in that the lamp post 320 includes merely a main post 320, and the air inlet 320a is defined in a bottom end of the main post 320, the illumination device 310 is assembled on the main post 320 between the air inlet 320a and the air outlet 320b.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A street lamp system, comprising:
a hollow lamp post having an air inlet and an air outlet, and an air flowing channel defined in the lamp post between the air inlet and the air outlet;
an illumination device comprising a solid-state light source and a heat dissipation device thermally coupled to the solid-state light source, the illumination device being coupled to the lamp post with the heat dissipation device disposed in the air flowing channel;
a generator electrically connected to the illumination device to supply electric energy to the illumination device;
a wind turbine mechanically coupled to and disposed outside the lamp post to be driven by wind energy to rotate;
a connecting shaft mechanically coupled to the wind turbine and the generator, the connecting shaft driven by the wind turbine to rotate, thereby driving the generator to generate electric energy;
a plurality of fan blades, mechanically coupled to the connecting shaft and disposed in the hollow lamp post to be driven by the connecting shaft to rotate, thereby directing flowing of the air in the channel from the air inlet to the air outlet.

2. The street lamp system of claim 1, wherein the lamp post comprises a main post and a subaltern post extending sideward from the main post, and the illumination device is arranged on the subaltern post.

3. The street lamp system of claim 2, wherein the air inlet is defined in an end of the subaltern post distal from the main post, the air outlet being defined in the main post.

4. The street lamp system of claim 1, further comprising a supporting post extending from the main post and a solar cell panel, the solar cell panel coupled to the supporting post to absorb and convert solar energy into electric energy and supply the electric energy to the solid-state light source.

5. The street lamp system of claim 1, wherein the illumination device further comprises a circuit board with the solid-state light source mounted thereon.

6. The street lamp system of claim 5, wherein the heat dissipation device comprises a base thermally contacting the circuit board, and a plurality of fins extending from the base.

7. The street lamp system of claim 6, wherein the fins of the dissipation device are parallel with a direction along the air flowing channel.

8. The street lamp system of claim 1, wherein the solid-state light source includes a light emitting diode.

9. The street lamp system of claim 1, further comprising an electric power storage for storing electric energy generated by the generator.

10. The street lamp system of claim 9, wherein the electric power storage includes a storage battery.
